(19) United States
(12) Patent Application Publication
(10) Pub. No.: US 2006/0247961 A1
(43) Pub. Date: Nov. 2, 2006

(54) Method and system for providing aggregation and display of notifications

(76) Inventor: Jason L. Klemow, Gaithersburg, MD (US)

Correspondence Address: DITTHAVONG & MORI, P.C., Suite A, 10507 Braddock Road, Fairfax, VA, 22032, US

(21) Appl. No.: 11/413,891

(22) Filed: Apr. 28, 2006

Related U.S. Application Data
(60) Provisional application No. 60/675,583, filed on Apr. 28, 2005.

(51) Int. Cl. G06F 9/46

(52) U.S. Cl. 705/8

(57) ABSTRACT

An approach is provided for electronic calendaring services. Notification information from a notification provider is converted to a tracking event. The tracking event is updated to reflect status information.

### RELATED APPLICATIONS

This application claims the benefit of the earlier filing date under 35 U.S.C. §119(e) of U.S. Provisional Application Ser. No. 60/675,583 filed Apr. 28, 2005, entitled “Method and Apparatus for Providing Aggregation and Display of Notifications,” the entirety of which is incorporated by reference.

### FIELD OF THE INVENTION

The present invention relates to electronic commerce and more particularly to notifications of events.

### BACKGROUND OF THE INVENTION

Calendars provide an indispensable tool for effective organization, both in business and personal applications. Electronic calendars have gain significant headway in supplanting paper based calendars, in that electronic calendars can be readily modified and electronically distributed. Given the popularity of the World Wide Web (the Web), calendaring over the Internet has received increasing attention. For example, many organizations have begun to utilize calendars over the Web to track events and provide scheduling, such that their membership is abreast of the activities and events of the organizations.

Conventionally, calendaring and scheduling services have limited capabilities. For example, different calendaring systems generally utilize differing proprietary protocols to maintain calendars, thereby restricting interoperability. That is, calendars cannot be easily shared or merged, if at all, across different hardware and software platforms. Such a problem is particularly germane to the Internet, which is a conglomeration of different internetworked computing platforms.

As the Web has grown in accessibility and richness of content, service providers have investigated mechanisms for providing access to notification of events. One such area is package delivery services. However, delivery services have been restricted in the manner in which they provide notifications, by having the user navigate to their site or a third party site to determine delivery status. Conventional systems have not satisfactorily addressed the ability to place tracking events into calendars for visual viewing shipping dates or estimated delivery dates.

Therefore, there is a need for a notification system that can support the accessing of notification events and deposit said events into user calendars. There is also a need to use standardized protocols for calendaring to ensure interoperability and ease of deployment.

### SUMMARY OF THE INVENTION

These and other needs are addressed by the present invention for providing an electronic notification system having interoperability with many different calendar applications. The above approach advantageously provides a standardized mechanism for sharing notification information.

According to one aspect of an embodiment of the present invention, a method of providing calendaring services is disclosed. The method includes converting notification information from a notification provider to a tracking event. The method also includes updating the tracking event to reflect status information.

According to another aspect of an embodiment of the present invention, an apparatus provides calendaring services. The apparatus includes a processor configured to convert notification information from a notification provider to a tracking event, wherein the processor is further configured to update the tracking event to reflect status information.

According to yet another aspect of an embodiment of the present invention, a method of providing an electronic calendar is disclosed. The method includes retrieving a tracking calendar, wherein the tracking calendar includes a tracking event generated from notification information from a notification provider. The method also includes determining whether access to the tracking calendar is authorized. Further, the method includes displaying the tracking calendar if the access is authorized.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a notification system to track notifications from notification providers to user's target calendars, according to an embodiment of the present invention;

FIG. 2 is a flowchart depicting the syndication of a tracking calendar and a calendar application accessing the tracking calendar containing tracking events, in accordance with an embodiment of the present invention;

FIGS. 3A and 3B are a flowchart depicting a process for adding of a notification event, according to an embodiment of the present invention;

FIG. 4 is a flowchart depicting a process for requesting tracking event updates, according to an embodiment of the present invention;

FIG. 5 is a flowchart depicting a process for receiving notification events, in accordance with an embodiment of the present invention;

FIG. 6 is a diagram of an exemplary form for adding package-based tracking events, in accordance with an embodiment of the present invention;

FIG. 7 is a diagram of an exemplary form for adding notification providers, in accordance with an embodiment of the present invention;

FIG. 8 is a diagram of an exemplary form for setting up notification providers, according to an embodiment of the present invention;

FIG. 9 is a diagram of a list view of a calendar, according to an embodiment of the present invention;

FIG. 10 is a diagram of a month view of a calendar, according to an embodiment of the present invention;

FIG. 11 is a diagram of a week view of a calendar, according to an embodiment of the present invention;

FIG. 12 is a diagram of a day view of a calendar, according to an embodiment of the present invention;

FIG. 13 is a diagram of an exemplary tracking event format compliant with a standardized iCalendar format, according to an embodiment of the present invention; and

FIG. 14 is a diagram of a computer system that can be used to implement an embodiment of the present invention.

### DESCRIPTION OF THE PREFERRED EMBODIMENT

A system, method, and software for providing an aggergation and display of notifcations are described. In the following desription, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

A notification system, according to one embodiment of the present invention, supports the aggregation of notification events from any notification provider, which can be converted to tracking events and deposited on user existing calendar application. The notification information to be tracked can be locally generated and stored, or fetched from a remote site, such as a web site.

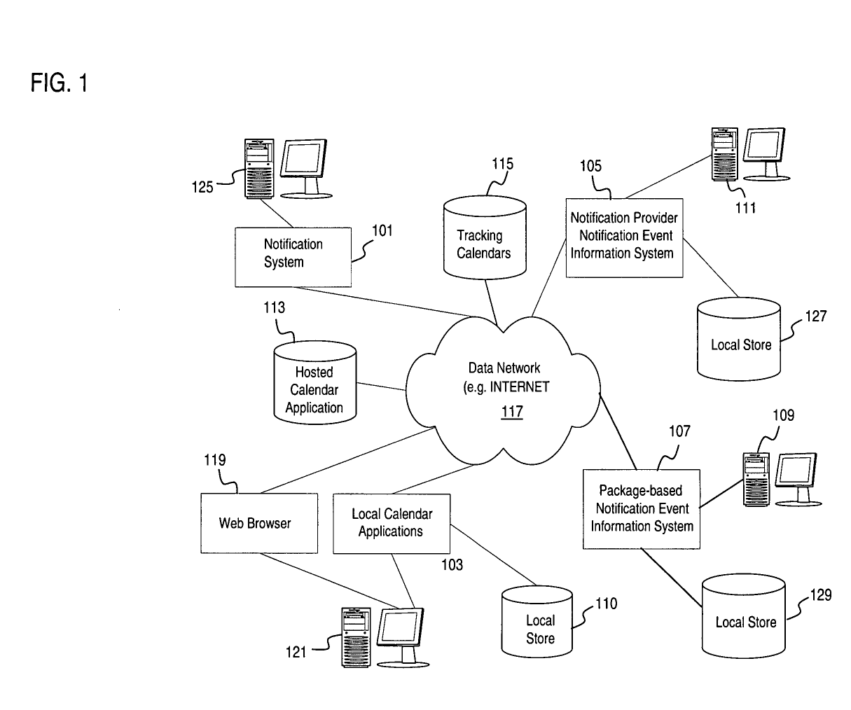

FIG. 1 is a diagram of a notification system to track information from notification providers to user's target calendars, according to an embodiment of the present invention. A notification system 101 can schedule and deposit calendar entries or tracking events on calendar applications 103. By way of example, these applications 103 can employ Internet-based interoperability protocols from the Internet Engineering Task Force (IETF). Terminologies and concepts relating to calendaring are described in IETF Request for Comment (RFC) 3283, entitled “Guide to Internet Calendaring”; RFC 2445, entitled “Internet Calendaring and Scheduling Core Object Specification (iCalendar),” RFC 2446, entitled “iCalendar Transport-Independent Interoperability Protocol (iTIP),” RFC 2447, entitled “iCalendar Message-Based Interoperability Protocol (iMIP)”; RFC 4324 entitled “Calendar Access Protocol (CAP)”; “Calendaring Extensions to WebDAV (CalDAV)”; RFC 4287, entitled “The Atom Syndication Format” the entireties of which are incorporated herein by reference.

Also, the applications 103 can employ other interoperability protocols, such as, the RSS, Simple Sharing Extensions, or other extensions, proprietary, or public protocols. RSS is a family of web feed formats, specified in eXtensible Markup Language (XML) and used for Web syndication. The objective of Simple Sharing Extensions (SSE) is to define the minimum extensions necessary to enable loosely-cooperating apps to use RSS as the basis for item sharing—that is, the bi-directional, asynchronous replication of new and changed items amongst two or more cross-subscribed feeds.

It is recognized that users (non-commercial consumers as well as business consumers) have a need to track packages affecting, for example, their households or businesses. Such packages, for instance, include legal and other important documents, mail-order pharmacy items, movie deliveries, and general online purchases. Many package senders provide the ability to access delivery status information through their respective notification event information systems 105; in this example, these senders are considered “notification providers.” In some cases, package senders utilize a delivery service and provide a package reference number of the delivery service in their notification event information system 105. Notification information from these package-reference numbers can be accessed from a package-based notification event information systems 107, which are operated by package-based delivery services providers 109. Examples of package-based delivery services providers include couriers, such as United Parcel Service (UPS), Federal Express (Fedex), DHL, and the United States Postal Service.

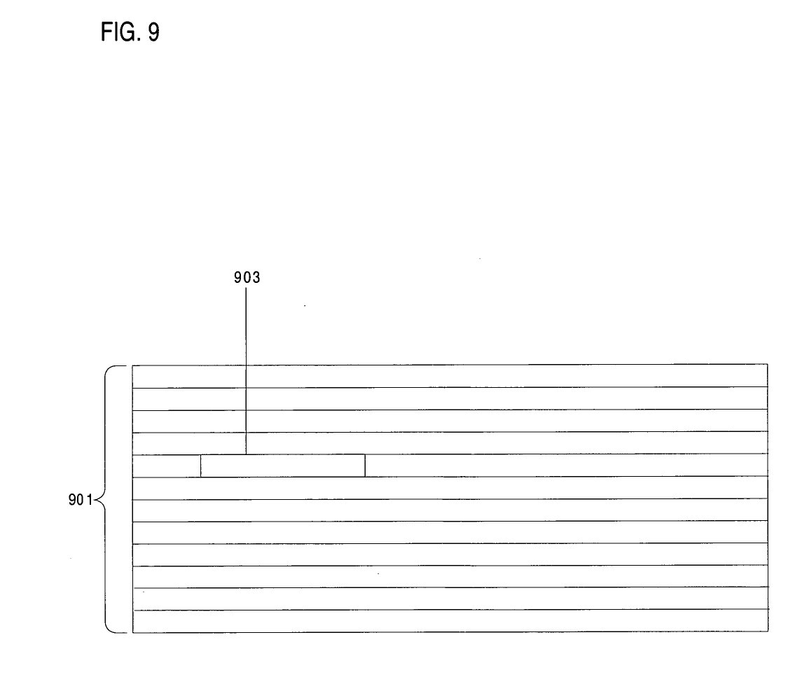

The notification system 101 provides, in an exemplary embodiment, a capability to create tracking events from notification providers 111 and add these tracking events to the target calendars. The target calendars, for instance, can be located on hosted calendar applications 113, local calendar applications 103, or as tracking calendars 115. The notification system 101 refreshes the information from the notification providers 111 and packaged-based notification providers 109 and updates the corresponding tracking events on hosted calendar applications 113, local calendar application 103 and/or updates the syndication to the tracking calendar 115. The tracking events are displayed on the end-user Calendars Views; such views can include List, Monthly, Weekly, and Daily Views, as shown in FIGS. 9-12, respectively.

As seen in FIG. 1, the notification system 101 has connectivity to a data network 117, which can be a public network such as the global Internet. The notification providers 111 maintain information on delivery dates and other notification information within notification event information system 105. The notification event information system 105 also has connectivity to the data network 117.

Calendaring clients, which can exist as local calendar applications 103 or hosted calendar applications 113, support the creation and viewing of events. Local calendar applications 103 utilize integrated calendar clients to support the creation and viewing of events. Hosted calendar application 113 utilizes, for example, Web browser clients 119 to support the creation and viewing of events. Both local calendar applications 103 and Hosted calendar applications 113 can interact with notification systems (e.g., system 101) across the Internet 117. By way of example, local calendar applications 103 can include the following: MICROSOFT Outlook, LOTUS Notes, NOVEL Groupwise, APPLE iCal or any other calendar application that supports all or some of the Internet Engineering Task Force (IETF) interoperability protocols and other interoperability protocols (e.g., RSS). The hosted calendar applications 113 can include the following: GOOGLE Calendar, YAHOO Calendar, MSN Hotmail Calendar, 30Boxes, Zimbra, Trumba, or any other calendar application that supports all or some of the IETF interoperability protocols and other interoperability protocols (e.g., RSS).

A web browser 119 is a software application that enables a user to display and interact with text, images, and other information typically located on a web page at a website on the World Wide Web (WWW) or a local area network (LAN). Exemplary browsers available for personal computers include MICROSOFT Internet Explorer, Mozilla Firefox, Opera, Netscape, and Apple Safari. Popular microbrewers designed for use on a handheld device such as a PDA or mobile phones include: Pocket Internet Explorer, Opera Mobile, and NOKIA Series 40 Browser.

According to one embodiment, the notification system 101 can store calendar entries or tracking events onto tracking calendars with database 115 in, for example, an iCalendar format. The tracking calendars can be accessible by calendar applications via web syndication. Web syndication is a form of syndication in which a section of a website, in this case, a tracking calendar, is made available to other sites, including calendar applications, for use.

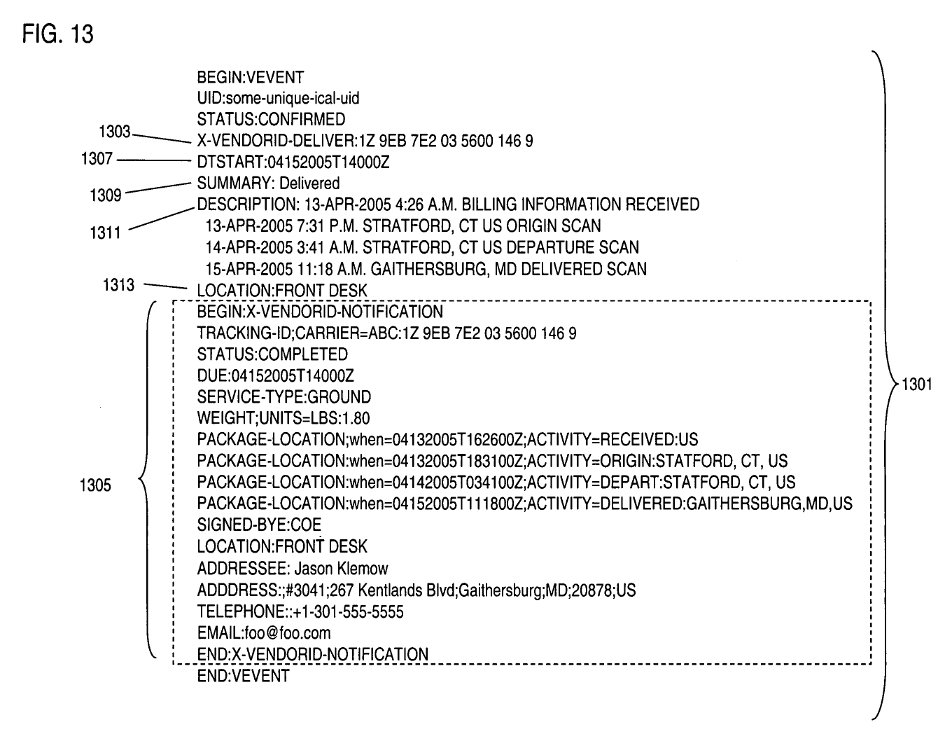

In addition, the notification system 101 obtains notification information from notification providers 111 and package-based notification providers 109. In one embodiment, the notification provider 111 allows automated access to the notification event information system 105 of all relevant notification events for the designated user. The notification system 101 converts the notification information into tracking events following the RFC 2445 iCalendar format (as shown in FIG. 13) and deposits the tracking events on the calendar application 103 using the methods supported by the calendar application, such as, iTIP, iMIP, CAP, or CalDAV.

Further, the notification system 101 can convert or transform package delivery information to tracking events directly from the package delivery information irrespective of the notification provider 111. Alternatively, the notification system 101 can convert the notification information into tracking events following the RFC 2445 iCalendar format (as shown in FIG. 13) and syndicates the tracking event into a tracking calendar 115 supporting all or some of the Internet Engineering Task Force (IETF) interoperability protocols and other interoperability protocols. The notification provider 111 responds with package reference numbers corresponding to delivery services of the package-based delivery provider 109. In this case, the notification system 101 accesses the package-based notification event information system 107 and converts the package-based notification information into tracking events following the RFC 2445 iCalendar format and deposits the tracking events on the calendar application 103 using the methods supported by the calendar application, such as, iTIP, iMIP, CAP, or CalDAV or syndicates the tracking event into a tracking calendar 115 using the methods supported by syndication protocols, such as, ATOM, RSS and SSE.

In one embodiment, the user 121 manually enters package tracking numbers that are read by the notification system 101. The notification system 101 accesses the package-based notification event information system 107 and converts the package-based notification information into tracking events following the RFC 2445 iCalendar format, for example. Further, the system 101 deposits the tracking events to the calendar application 103 or 113, using the requested method as supported by the calendar application, such as, iTIP, iMIP, CAP, or CalDAV or syndicates the tracking event into a tracking calendar stored within database 115 using the methods supported by syndication protocols (e.g., Atom, RSS and SSE, etc.). In this manner, the tracking events can be stored and updated within the tracking calendar, which can be accessible to calendar applications through syndication.

Moreover, under this exemplary scenario, the user 121 may maintain a local store 123 of notification information. For example, a business that ships packages out and maintains a list of package reference numbers in another system. The user 121 would be its own notification provider, and the notification system 101 would convert the events into tracking event as described above. As shown, the notification system 101 is accessible by a host (or user) 125; the user 125, for example, can be a system administrator, or any authorized user. Additionally, the notification provider 111 and the package-based notification event information system 107 maintain notification information in local stores 127 and 129, respectively.

Also, although the above calendaring service is described with respect to a single notification provider 111, it is contemplated that tracking calendars can be created to aggregate tracking events from multiple notification providers or multiple “accounts” on a single notification provider.

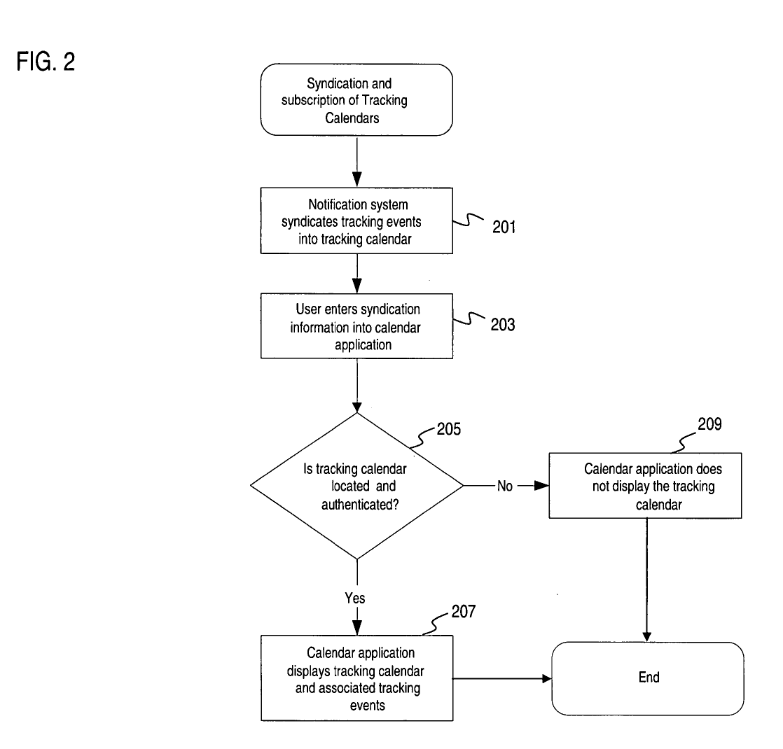

FIG. 2 is a flowchart depicting the syndication of a tracking calendar and a calendar application accessing the tracking calendar containing tracking events, in accordance with an embodiment of the present invention. A tracking calendar, in an exemplary embodiment, specifies notification events from the notification provider 111, along with the details of the notification, such as, delivery status and estimated timeframes from the notification provider 111. The notification system 101 syndicates the notification event into a tracking calendar with, in an exemplary embodiment, a designated Uniform Resource Locator (URL), per step 201. A URL is a string of characters conforming to a standardized format, which refers to a resource on the Internet, in this case a iCalendar Formatted Calendar, by its location. The tracking calendar may require authorization, such as, user name and password to access.

Calendar applications supporting syndication of iCalendar Formatted Calendars subscribe to the syndicated calendar, per step 203. The user 121 enters the URL and authorization (if required and if supported based on the specific calendar applications calendar subscription process). The calendar application, per step 205, connects to the Internet 117 to locate and authorize, if required, the tracking calendar; and if successful, the tracking calendar and associated tracking events are displayed within the calendar application, per step 207. The tracking events are displayed on the end-user calendars views. Such views can include List, Monthly, Weekly, and Daily Views, as shown in FIGS. 9, 10, 11 and 12, respectively. If the URL associated with the tracking calendar is not located on the Internet 117 or authorization fails, the tracking calendar is not displayed. It is noted that specific calendar applications may provide details on the failure, per step 209, to the user 121.

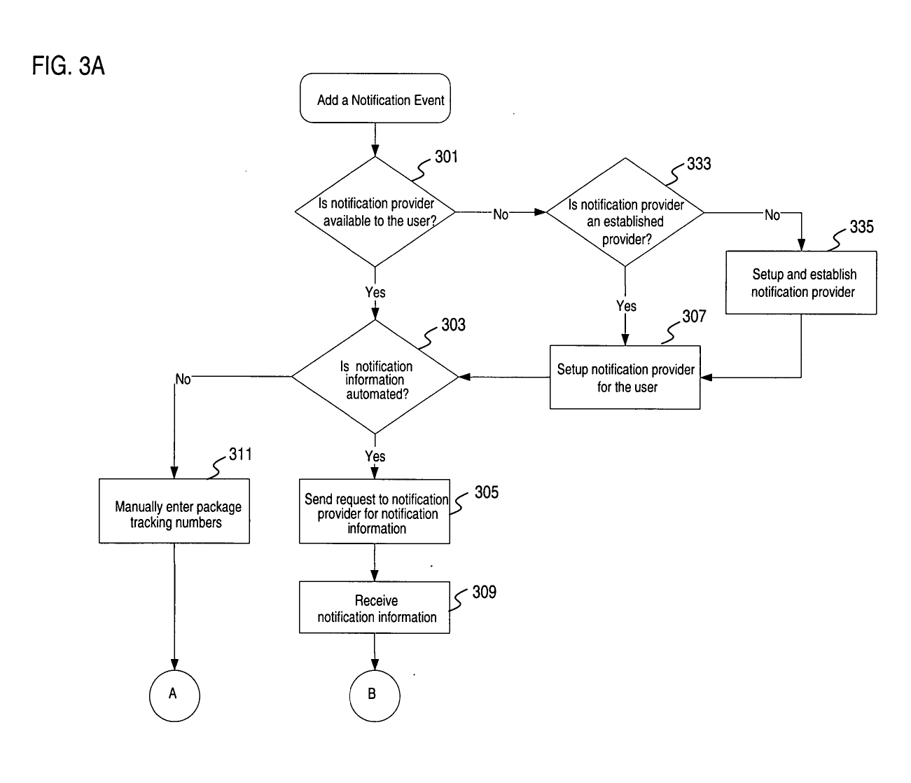

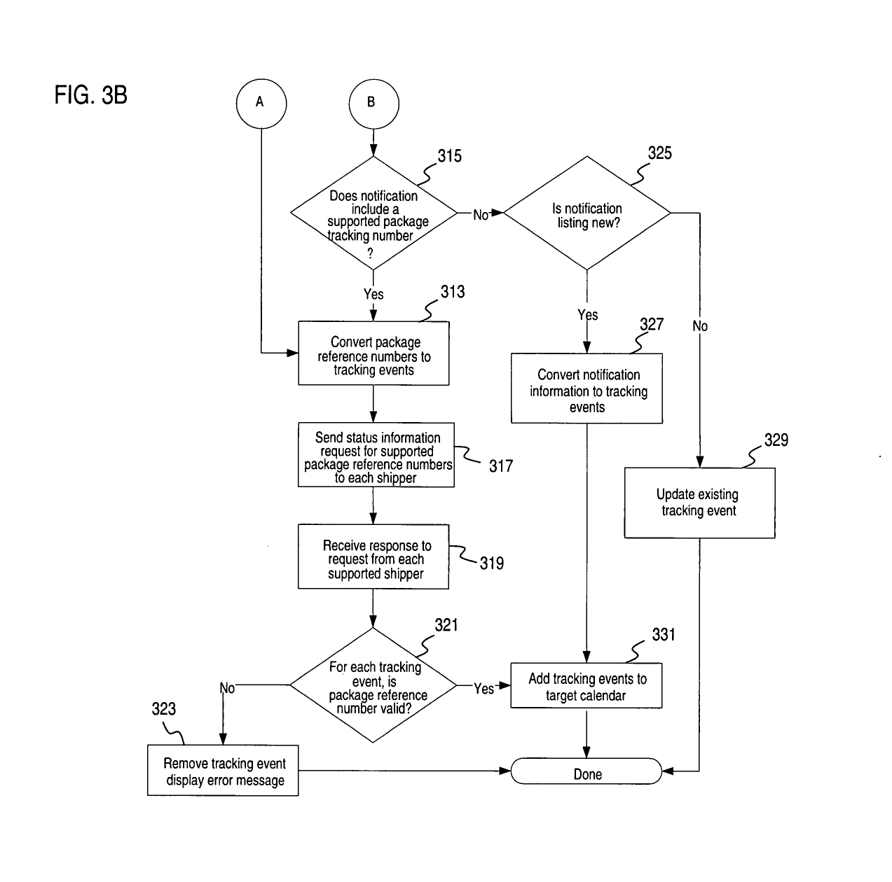

FIGS. 3A and 3B are a flowchart depicting a process for adding of a notification event, according to an embodiment of the present invention. A notification event, in an exemplary embodiment, specifies identifying information from a notification provider 111, along with a method to request the details of the notification, such as, delivery status and estimated timeframes from the notification provider 111. The notification system 101 determines whether the notification provider 111 is available for requests, per step 301.

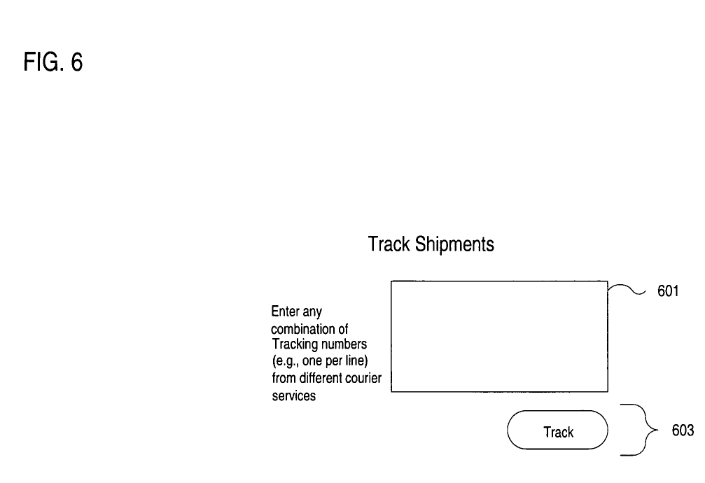

Requests from providers 111 (and/or 109) can be performed ad-hoc via a manual entry form, or automated via the entry of user information required by the notification provider, (as determined per step 303). If automated, a request for notification event information, as in step 305, is made to the notification provider on a periodic basis. The request includes the required information, as setup per step 307, and the notification provider 111 returns notification information to the notification system 101 (step 309). A package tracking number that is entered manually, per step 311, via a manual entry form (as explained in FIG. 6), as determined per step 301, can be converted to a tracking event per step 313 (FIG. 3B).

In step 315 (shown in FIG. 3B), the process determines whether the notification includes a supported package tracking number. The notification information can be in the format of a package tracking number from a different established notification provider. A package tracking number is a subset notification event, used by delivery and mail services, such as United Parcel Service (UPS), Federal Express (FedEx), DHL, and the United States Postal Service. If so, each received package tracking number is converted into separate package-based tracking events, per step 313. In step 317, the notification system 101 sends a status information request for notification event information from the supported package-based notification providers.

Information returned in step 309 may include multiple packages tracking numbers from multiple package-based notification providers 111. In step 319, a response to the request is received for each supported notification provider 111 or package provider 109 (e.g., shipper). For each package-based tracking event information return, the notification system 101 validates the information, per step 321. If the information returned in step 319 is determined to be invalid, then an error message is provided to the end user, and the tracking event is removed from the notification system 101 (step 323).

If the notification information returned (per step 309) is determined not to be a package tracking number (per step 315), the notification system 101 determines whether the notification events returned are new based on a comparison of previously returned notification events from the notification provider, per step 325. In an exemplary embodiment, the notification providers 111 provide a listing of all notification events at one time.

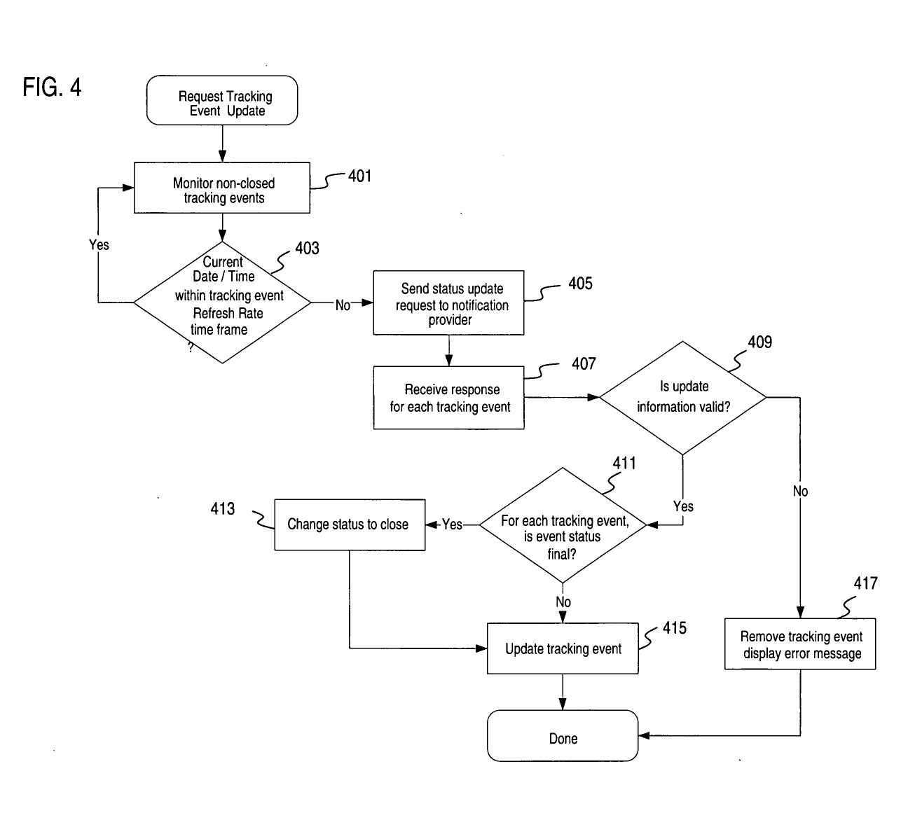

In step 327, the notification system 101 converts each notification event returned to a tracking event. If the notification events returned, per step 309, are determined not to be new per step 325, the notification system 101, compares each notification event with the corresponding tracking events and updates the tracking event with any new information returned, per step 329. In another example, notification providers can separate previously requested notification events and new events. In this example, existing tracking events corresponding to existing individual notifications are monitored (as more fully described in FIG. 4).

In step 331, new tracking events are added to the users target calendar from either new valid package-based tracking events (per step 321) or new converted notification events (per step 327).

Returning to the decision of step of 301 (FIG. 3A), if the notification provider 111 is not available to the user, the user determines whether the notification provider 111 is an established provider within the notification system 101, per step 333. If not, the notification system 101 supports the setup of notification providers as in step 335, whereby an administrator, via the administrator host 125, can create a new notification providers or edit an existing notification provider. If a notification provider has been previously setup, then users, per step 307, setup notification providers to their authorized list.

FIG. 4 shows a flowchart depicting a process for requesting tracking event updates, according to an embodiment of the present invention. Each tracking event corresponds to a notification event from the notification provider 111. In step 401, the notification system 101 monitors all non-closed tracking events, wherein the notification provider 111 can provide individual notification information. This monitoring process can be performed according to a predetermined refresh or update period, i.e., per a refresh rate. For instance, in step 403, the notification system 101 determines whether the current date/time equals or exceeds the specified next refresh date/time for each tracking event; if not, the system 101 continues to monitor the tracking event. However, when the notification system date/time is equal to or surpasses the next refresh schedule date/time, a request for the latest notification information is sent. The notification system 101 sends, as in step 405, update requests to each supported notification provider and receive updates in response to the request (per step 407).

Each updated tracking event is validated (as determined in step 409). If valid, the notification system 101 determines whether the status update is the final update for tracking event, as in step 411. If so, the tracking event status is changed to close, per step 413. Closed events are no longer monitored. Next, all valid tracking events are updated, as in step 415, and the users target calendar are updated.

Returning to step 409, if the information returned is determined to be invalid, then an error message is provided to the end user, and the tracking event is removed from the notification system 101, as in step 417.

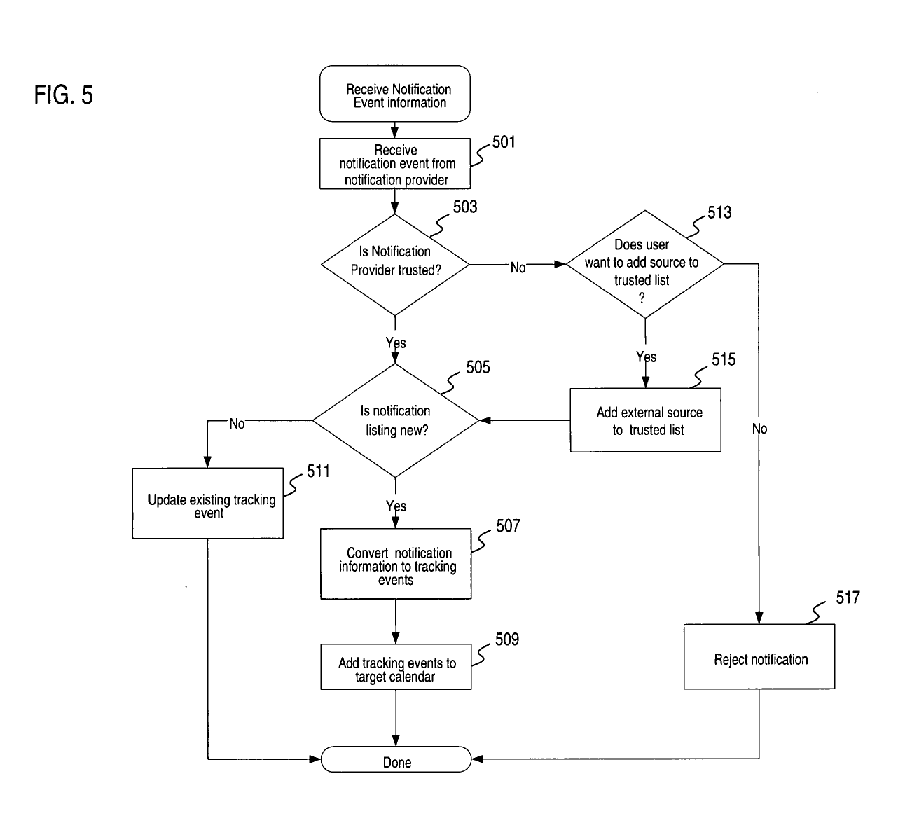

FIG. 5 shows a flowchart depicting a process for receiving notification events, in accordance with an embodiment of the present invention. Notification providers 111 can send new notification events, updates to new notification events, and updates to existing tracking events directly to users' target calendars. In step 501, the notification events are received. Next, the notification system 101 determines whether the notification provider 111 is a trusted provider (step 503), and accordingly validates the notification provider 111 as a trusted notification provider. In an exemplary embodiment, the notification provider 111 need not be the originating source of the notification events. That is, notification providers may be aggregators of notification events from other notification providers.

If the notification provider is trusted, then the notification system 101 compares the notification event with existing tracking events to determine if it is new (as in step 505). If new, the notification system 101 converts the notification information to a tracking event, per step 507, and adds the tracking event to the users target calendar (step 509). However, if the notification information is not new, then the existing tracking event is updated, per step 511.

If the notification provider is not a trusted provider, then the user is prompted and asked if the notification system 101 should trust the notification provider, per step 513. If so, the notification provider is added to the trusted provider list as directed by the user (per step 515), and the process continues with step 505 as referenced above. If the user deems the notification provider to be un-trusted, then the notification event is rejected in step 517.

FIG. 6 shows a diagram of an exemplary form for adding package-based tracking events, according to an embodiment of the present invention. A package-based tracking event setup function, as supported by the notification system 101, permits the user to create (add) a new package-based tracking event to a target calendar. To setup a package-based tracking event, the user opens the respective form and enters a list of package tracking number field 601. Package tracking numbers entered into field 601, in one embodiment, can be from different courier services. The form may be integrated with the user calendar application or through an internet browser communicating via HyperText Transfer Protocol (HTTP) with the notification system 101. Upon completion of the form, the user saves the information using the Track button 603.

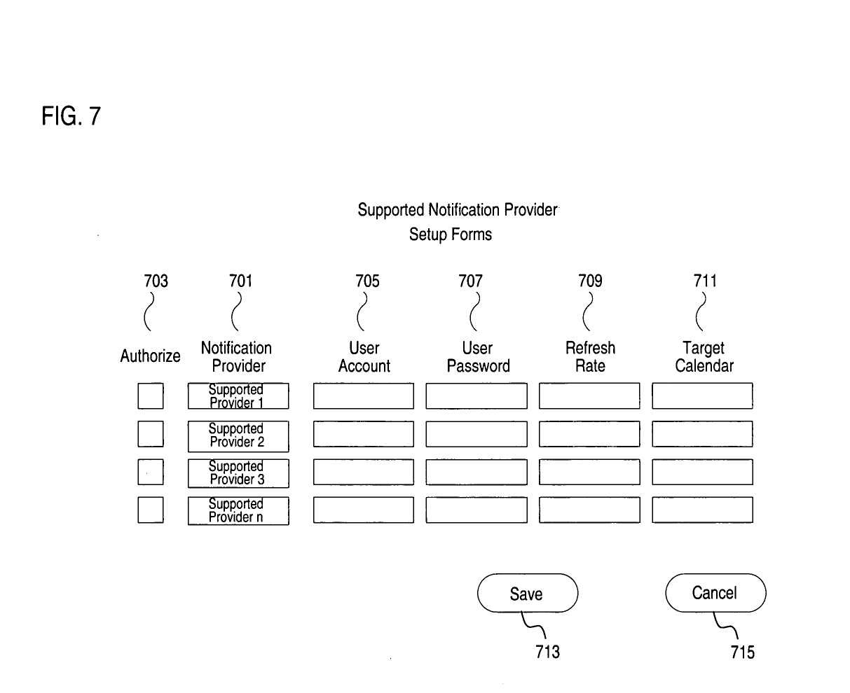

FIG. 7 shows a diagram of an exemplary form for adding notification providers, in accordance with an embodiment of the present invention. A supported notification provider setup function, as supported by the notification system 101, permits the user to add and edit a supported notification provider for obtaining the user's notification events. To setup a supported notification provider, the user opens the respective form and picks from a list of supportive notification providers 701 and enters the setup information, which can include the following fields: an Authorize Check Box Field 703, User Account Number Field 705, User Password Information Field 707, User Refresh Rate Field 709, and Target Calendar Field 711. The User Account Number Field 705 and User Password Information Field 707 represent the user's login information for the selected notification provider 701. The Authorize Check Box Field 703 provides the notification system 101 with permission to access the notification provider's notification event information system 105 on behalf of the user. The Refresh Rate Field 709 enables users to choose how often to query the notification provider's notification event information system 105. The Target Calendar field 711 is to designate where the tracking event is deposited; e.g., the options include local calendar applications 103, hosted calendar applications 113, and tracking calendars 115. Also, the Target Calendar field 711 can be designated as an URL or as an URL with authorization information. Upon completion of the form, the user saves the information using the Save button 713. A Cancel button 715 permits the user to cancel the setup process.

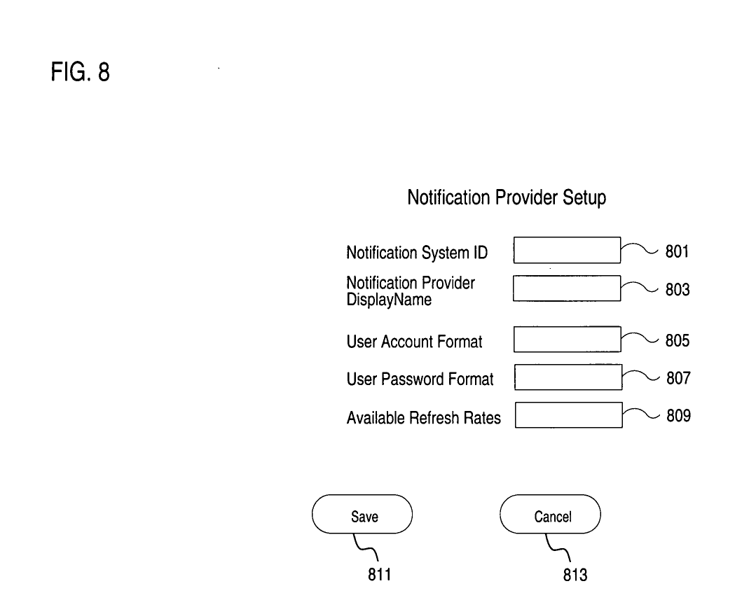

FIG. 8 shows a diagram of an exemplary form for setting up notification providers, according to an embodiment of the present invention. A notification provider setup function, as supported by the notification system 101 whereby an administrator, via the administrator host 125, can create new notification providers or edit an existing supported notification provider. To setup a notification provider 111, the user opens the respective form enters the Setup Information including the following exemplary fields: Notification System ID (identification) Field 801, Notification Provider Display Name Field 803, User Account Number format Field 805, User Password Format Field 807, Available Refresh Rates Field 809. The Notification System ID 801 is used as an internal reference number within the notification system 101. The Notification Provider Display Name 803 specifies the text shown to users in on the Supportive Notification Providers field 701. Each notification provider 111 may have specific formats required when entering user account and password information.

The User Account Format 805 and User Password Format 807 fields are available to set the required formats provided to end user when entering information into the User Account Number Field 705 and User Password Information Field 707, respectively. By way of example, “obscure” is one format, which is used to hide typed text for privacy. If the notification provider 111 specifies limits on querying the notification event information system 105, these limits can be incorporated into the Available Refresh Rates Field 809. Upon completion of the form, the administrator saves the information using the Save button 811. Alternatively, the user can cancel the process with the Cancel button 813.

It is recognized that setup forms of FIGS. 7 and 8 can be tailored to the particular provider, thus, the exact format of the form will depend on the notification system 101 and the notification provider's requirements.

FIG. 9 shows a diagram of a list view of a calendar, according to an embodiment of the present invention. In this example, the List View Calendar View provides for a grid with a single column for the time period being displayed and multiple rows to represent the different days within the time period 901. Tracking events are shown within a single block based on the user's preference of shipment date/time or estimated delivery date/time 903.

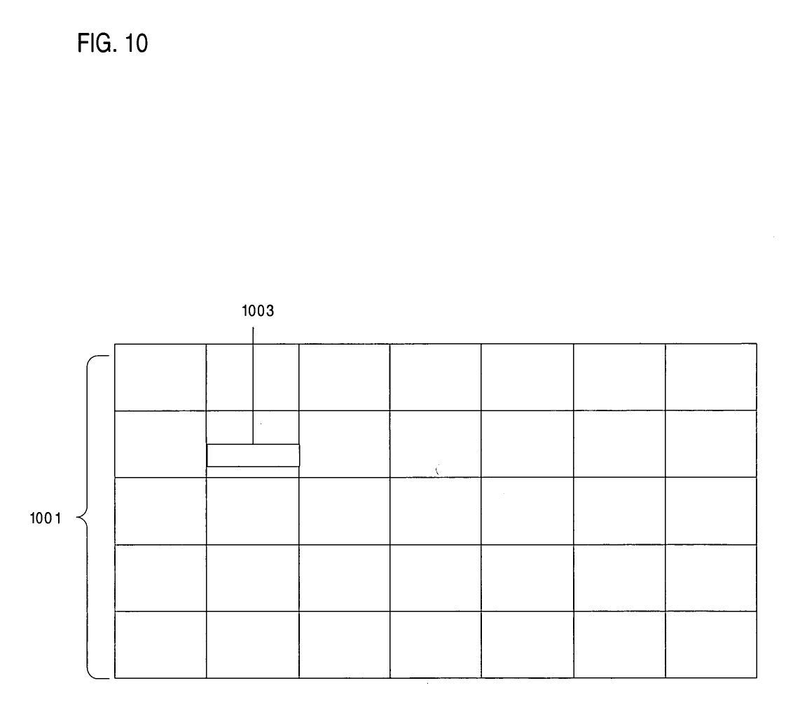

FIG. 10 shows a diagram of a month view of a calendar, according to an embodiment of the present invention. The Month View Calendar View, in an exemplary embodiment, provides for a grid with 7 columns for the days of the week and 5 rows where each day in the month is shown within its own block 1001. Tracking events are shown within a single block based on the user's preference of shipment date or estimated delivery date 1003.

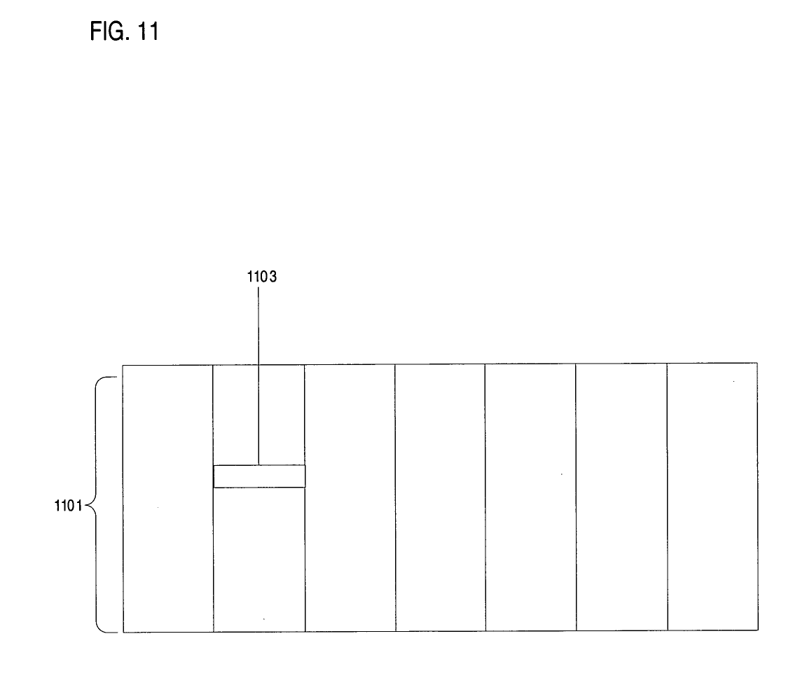

FIG. 11 shows a diagram of a week view of a calendar, according to an embodiment of the present invention. The Week View Calendar View provides for a grid with 7 columns for the days of the week and 1 row where each day in the week is shown within its own block 1101. Tracking events are shown within a single block based on the user's preference of shipment date or estimated delivery date 1103.

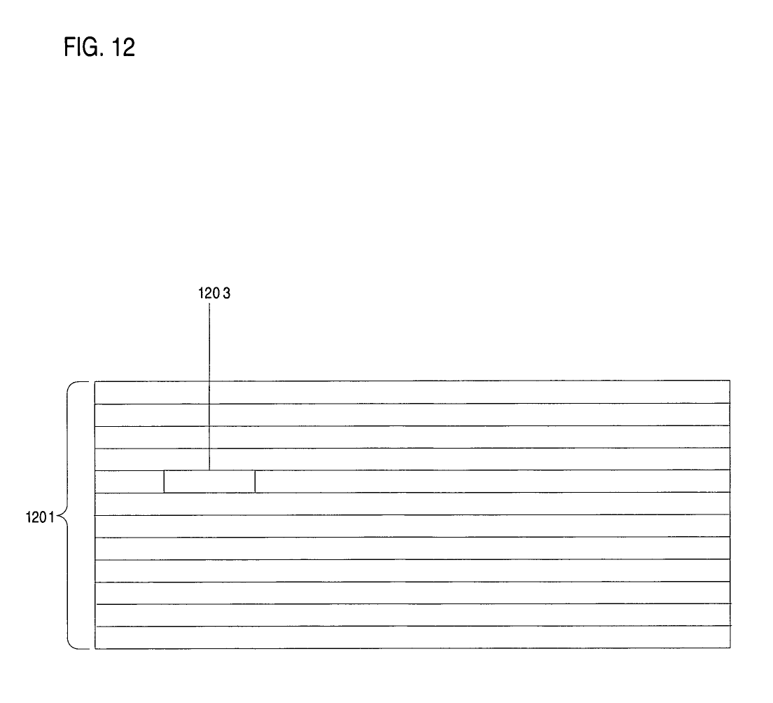

FIG. 12 shows a diagram of a day view of a calendar, according to an embodiment of the present invention. The Day View Calendar View, for instance, provides for a grid with a single column for the specific day of the week and multiple rows to represent the hours within the day 1201. Tracking events are shown within a single block based on the user's preference of shipment date/time or estimated delivery date/time 1203.

FIG. 13 is a diagram of an exemplary tracking event format compliant with a standardized iCalendar format, according to an embodiment of the present invention. For the purposes of illustration, the RFC 2445 iCalendar format is described with respect to the calendar applications 103, hosted calendar application 113, and tracking calendars 115 (of FIG. 1). The interoperable tracking event can be a stand-alone, VEVENT 1301, a VEVENT 1301 with a X Property 1303, or a VEVENT 1301 with a X Component 1305. A VEVENT 1301 as defined in RFC 2445, is a calendar component which includes a grouping of component properties that represents a scheduled amount of time on a calendar.

According to one embodiment of the present invention, the component properties indicate a date time starting reference (DTSTART) 1307 property. For example, DTSTART 1307 can represent the date time the item was shipped, the item's estimated delivery date, or the item's actual delivery date. Prior to the date being determined DTSTART 1307 may be the VEVENTs create date. The X Component 1305, which is labeled in this example as: X-VENDORID-Notification and the X Property 1303, which is labeled is this example as X-VENDORID-Deliver 1303 are vendor-specific additions, as described in RFC 2445 which allows addition components, properties, and parameters to calendar components. The X Property 1303 which is labeled in this example as: X-VENDORID-DELIVER is used to store the package tracking number. The X Component 1305, which is labeled in this example as: X-VENDORID-Notification is used to store specific details of the tracking event as obtained from the notification provider event information system 111 or the Package-based notification event information system 107. It is recognized that X Component 1305 can be tailored to the particular provider; thus, the exact format of the component will depend on the notification system 101 and the requirements of the notification provider 111.

A sample of other component properties are listed in VEVENT 1301 including Unique Identifier (UID), STATUS, SUMMARY, DESCRIPTION and LOCATION. These properties and others are more fully defined in RFC 2445.

The calendar applications 103 and Hosted Calendars application 113 can process valid VEVENTs 1301 and deposit them on a user's calendar automatically or after acceptance by the user. In processing these VEVENTs 1301, the calendar applications 103 and/or hosted calendar application 113 may ignore other vendors specific components, properties, and parameters. Therefore, to provide interoperability to multiple calendar applications 103 and hosted calendar application 113, notification information is provided in the interoperable portions of VEVENT, such as, the SUMMARY 1309 and DESCRIPTION 1311 fields. For calendar applications 103 and hosted calendar application 113, which can support the X-VENDORID-Deliver property 1303 or X-VENDORID-Notification component 1305, the notification information can be processed along with the VEVENT information and deposited on the user's target calendar.

According to an embodiment of the present invention, if the optional X-VENDORID-Deliver property 1303 is used, then the property provides a hyperlink to the X-VENDORID-Notification component 1305, stored on the notification system 101. If the optional X-VENDORID-Notification component 1305 is used, then all the notification information is within the VEVENT 1301, as shown. VEVENTs 1301 may include none, one, or both optional properties. In one embodiment, the iCalendar standard field Location 1313 may be text-based or contain information to geographic information for mapping services.

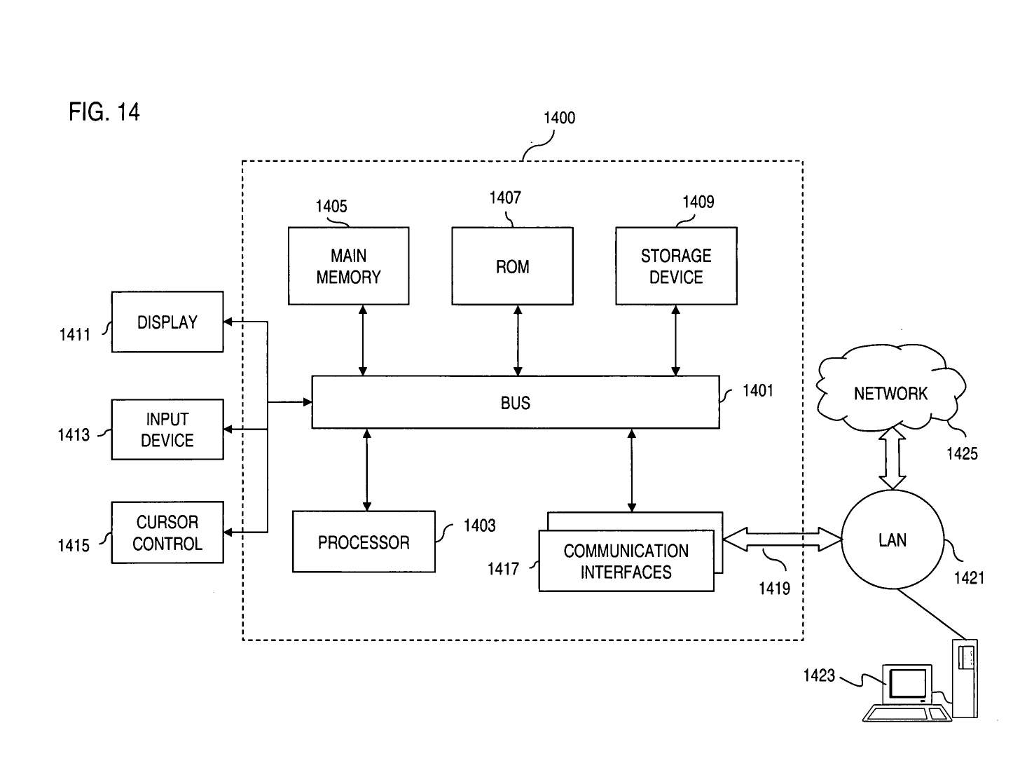

One of ordinary skill in the art would recognize that the processes for providing aggregation and display of notifications within electronic calendars may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 14.

FIG. 14 illustrates a computer system 1400 upon which an embodiment according to the present invention can be implemented. The computer system 1400 includes a bus 1401 or other communication mechanism for communicating information and a processor 1403 coupled to the bus 1401 for processing information. The computer system 1400 also includes main memory 1405, such as a random access memory (RAM) or other dynamic storage device, coupled to the bus 1401 for storing information and instructions to be executed by the processor 1403. Main memory 1405 can also be used for storing temporary variables or other intermediate information during execution of instructions by the processor 1403. The computer system 1400 may further include a read only memory (ROM) 1407 or other static storage device coupled to the bus 1401 for storing static information and instructions for the processor 1403. A storage device 1409, such as a magnetic disk or optical disk, is coupled to the bus 1401 for persistently storing information and instructions.

The computer system 1400 may be coupled via the bus 1401 to a display 1411, such as a cathode ray tube (CRT), liquid crystal display, active matrix display, or plasma display, for displaying information to a computer user. An input device 1413, such as a keyboard including alphanumeric and other keys, is coupled to the bus 1401 for communicating information and command selections to the processor 1403. Another type of user input device is a cursor control 1415, such as a mouse, a trackball, or cursor direction keys, for communicating direction information and command selections to the processor 1403 and for controlling cursor movement on the display 1411.

According to one embodiment of the invention, the processes in support of aggregation and display of notifications are provided by the computer system 1400 in response to the processor 1403 executing an arrangement of instructions contained in main memory 1405. Such instructions can be read into main memory 1405 from another computer-readable medium, such as the storage device 1409. Execution of the arrangement of instructions contained in main memory 1405 causes the processor 1403 to perform the process steps described herein. One or more processors in a multi-processing arrangement may also be employed to execute the instructions contained in main memory 1405. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computer system 1400 also includes a communication interface 1417 coupled to bus 1401. The communication interface 1417 provides a two-way data communication coupling to a network link 1419 connected to a local network 1421. For example, the communication interface 1417 may be a digital subscriber line (DSL) card or modem, an integrated services digital network (ISDN) card, a cable modem, a telephone modem, or any other communication interface to provide a data communication connection to a corresponding type of communication line. As another example, communication interface 1417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1417 sends and receives electrical, electromagnetic, or optical signals that carry digital data streams representing various types of information. Further, the communication interface 1417 can include peripheral interface devices, such as a Universal Serial Bus (USB) interface, a PCMCIA (Personal Computer Memory Card International Association) interface, etc. Although a single communication interface 1417 is depicted in FIG. 14, multiple communication interfaces can also be employed.

The network link 1419 typically provides data communication through one or more networks to other data devices. For example, the network link 1419 may provide a connection through local network 1421 to a host computer 1423, which has connectivity to a network 1425 (e.g. a wide area network (WAN) or the global packet data communication network now commonly referred to as the “Internet”) or to data equipment operated by a service provider. The local network 1421 and the network 1425 both use electrical, electromagnetic, or optical signals to convey information and instructions. The signals through the various networks and the signals on the network link 1419 and through the communication interface 1417, which communicate digital data with the computer system 1400, are exemplary forms of carrier waves bearing the information and instructions.

The computer system 1400 can send messages and receive data, including program code, through the network(s), the network link 1419, and the communication interface 1417. In the Internet example, a server (not shown) might transmit requested code belonging to an application program for implementing an embodiment of the present invention through the network 1425, the local network 1421 and the communication interface 1417. The processor 1403 may execute the transmitted code while being received and/or store the code in the storage device 1409, or other non-volatile storage for later execution. In this manner, the computer system 1400 may obtain application code in the form of a carrier wave.

The term “computer-readable medium” as used herein refers to any medium that participates in providing instructions to the processor 1403 for execution. Such a medium may take many forms, including but not limited to non-volatile media, volatile media, and transmission media. Non-volatile media include, for example, optical or magnetic disks, such as the storage device 1409. Volatile media include dynamic memory, such as main memory 1405. Transmission media include coaxial cables, copper wire and fiber optics, including the wires that comprise the bus 1401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

Accordingly, the present invention provides notification information in a format readable via electronic calendars. The notification information can be accessed by the users' local calendar applications or via web-based Calendar applications or provided to users by any type of electronic medium.

While the present invention has been described in connection with a number of embodiments and implementations, the present invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method of providing calendaring services, the method comprising:
converting notification information from a notification provider to a tracking event; and
updating the tracking event to reflect status information.

2. A method according to claim 1, wherein the tracking event specifies a tracking number to track a package.

3. A method according to claim 1, comprising:
creating a tracking calendar for storing a plurality of tracking events aggregated from one or more notification providers, wherein the tracking calendar is accessible by a calendar application.

4. A method according to claim 3, further comprising:
syndicating the tracking event into the tracking calendar.

5. A method according to claim 4, further comprising:
assigning a Uniform Resource Locator (URL) to the tracking calendar.

6. A method according to claim 1, further comprising:
refreshing notification information from the notification provider.

7. An apparatus of providing calendaring services, the apparatus comprising:
a processor configured to convert notification information from a notification provider to a tracking event, wherein the processor is further configured to update the tracking event to reflect status information.

8. An apparatus according to claim 7, wherein the tracking event specifies a tracking number to track a package.

9. An apparatus according to claim 7, comprising:
creating a tracking calendar for storing a plurality of tracking events aggregated from one or more notification providers, wherein the tracking calendar is accessible by a calendar application.

10. An apparatus according to claim 9, further comprising:
syndicating the tracking event into the tracking calendar.

11. An apparatus according to claim 10, further comprising:
assigning a Uniform Resource Locator (URL) to the tracking calendar.

12. An apparatus according to claim 7, further comprising:
refreshing notification information from the notification provider.

13. A method of providing an electronic calendar, the method comprising:
retrieving a tracking calendar, wherein the tracking calendar includes a tracking event generated from notification information from a notification provider;
determining whether access to the tracking calendar is authorized; and
displaying the tracking calendar if the access is authorized.

14. A method according to claim 13, wherein the tracking event specifies a tracking number to track a package.

15. A method according to claim 13, comprising:
subscribing to a calendar syndication service for access to the tracking calendar.

16. A method according to claim 13, further comprising:
inputting a Uniform Resource Locator (URL) to retrieve the tracking calendar.

17. A method according to claim 13, wherein the tracking calendar is stored in a remote database.

18. A method according to claim 13, further comprising:
communicating with a notification system configured to interface with the notification provider for updates of the notification information.

19. A method according to claim 13, wherein the tracking calendar stores a plurality of tracking events aggregated from one or more notification providers.

20. A method according to claim 13, further comprising:
receiving a prompt to determine whether the notification provider is a trusted provider.
